(19) United States
(12) Patent Application Publication
(10) Pub. No.: US 2009/0318314 A1
(43) Pub. Date: Dec. 24, 2009

(54) CORE FOR PROPPANT AND PROCESS FOR ITS PRODUCTION AND USE

(75) Inventors: Lars Leidolph, Erfurt (DE); Ulrich Weitz, Berlin (DE); Toralf Rensch, Weimar (DE)

Correspondence Address: HEXION SPECIALTY CHEMICALS, INC., 12650 Directors Drive, Suite 100, Stafford, TX, 77477, US

(73) Assignee: Hexion Specialty Chemicals. Inc.

(21) Appl. No.: 12/508,197

(22) Filed: Jul. 23, 2009

Related U.S. Application Data
(63) Continuation-in-part of application No. 11/651,692, filed on Jan. 10, 2007.

(30) Foreign Application Priority Data
Jan. 23, 2006 (DE) 10 2006 003 289.6

(51) Int. Cl. C09K 8/92

(52) U.S. Cl. 507/204; 507/219

(57) ABSTRACT

The invention relates to a core which is formed from a raw material mixture comprising at least a solid powder resin and a further finely divided starting material, and which, in the thermally treated state, has a density of less than 2 g/cm³.

The invention further relates to a process for producing cores, in which raw material components are mixed to give a raw material mixture and granulated to form cores, and the latter are subsequently subjected to a thermal treatment in the temperature range of 120° C. to 220° C.

### RELATED APPLICATION DATA

This application is a continuation in part of U.S. patent application Ser. No. 11/651,692 filed Jan. 10, 2007, which claims the benefit of German Patent Application No. 10 2006 003 289.6 filed Jan. 23, 2006, the entire contents of both of which are hereby fully incorporated by reference.

### FIELD OF THE DISCLOSURE

The invention relates to a core which is particularly suitable for use in crude oil and natural gas extraction. The invention further relates to a process for producing such a core and the core's use as a proppant in the field of hydrofracturing geological formations.

### SUMMARY OF THE DISCLOSURE

In one aspect the invention is a proppant prepared using a core which is formed from a raw material mixture including at least a solid powder resin and a further finely divided starting material, and has been thermally treated at a temperature not exceeding about 220° C., and which in the thermally treated state, has a density of less than 2 g/cm³.

In another aspect, the invention is a process for producing a core for use in a proppant, the process including mixing the raw material mixture components to form a raw material mixture and granulating to form cores, then subjecting the cores to a thermal treatment in the temperature range of about 120° C. to about 220° C.

In still another aspect, the invention is a process for treating an underground geological formation including introducing a proppant into the underground geological formation wherein the proppant is prepared using a core which is formed from a raw material mixture including at least a solid powder resin and a further finely divided starting material, and has been thermally treated at a temperature not exceeding about 220° C., and which in the thermally treated state, has a density of less than 2 g/cm³.

### BRIEF DESCRIPTION OF THE DRAWINGS

For a detailed understanding of the present disclosure, reference should be made to the following detailed description of the one mode embodiments, taken in conjunction with the accompanying drawings, in which like elements have been given like numerals, wherein:

FIG. 1 is a schematic sectional view of a core without coating;

FIG. 2 Is a schematic sectional view of a core with coating;

FIG. 3 is a schematic view of a rotary tube oven system for the thermal treatment; and

FIG. 4 is a schematic view of a fluidized bed system for the thermal treatment.

### DETAILED DESCRIPTION OF THE DISCLOSURE

Crude oil and natural gas deposits are present in porous geological formations. The permeability of the rock formation is crucial for the economic exploitation of these deposits. Frequently, the permeability of the rock formation falls over the period of extraction, so that the exploitation of the deposits becomes uneconomic; sometimes, the permeability is too low even from the outset. In these cases, the rock formations are broken up hydraulically by injecting liquids under sufficiently high pressure to generate stresses and consequently fractures and capillaries which improve the permeability.

In order to keep the geological formation open in a lasting manner even with declining pressure, proppants are additionally introduced. As the pressure declines, the proppants form a packing which serves to keep the fractures and the geological formation in general open. The aim of the use of proppants is to increase gas and/or oil production by providing a channel in the formation which is capable of transporting oil and/or gas to a high degree.

The necessary properties are evident from the field of use of the so-called proppants. Crucial features are, for example, high fracture resistances of the proppants in combination with low density, high acid resistance and very good roundness.

High fracture resistances are required since a fine fraction otherwise forms as a result of bursting of cores under the action of the rock mass pressure, and in turn reduces the necessary transport capacity of the channels within the formation. The extraction capacity thus falls in an undesired manner. The fracture resistance is reported in % by mass and is typically carried out by the standard test (see API RP 60 of the American Petroleum Institute) using 13,780 kPa (2,000 psi). Fracture resistances reported below are based on this standard test method.

Low densities of the proppants are advantageous because high-density cores can be transported less efficiently in the case of transport by means of liquid transport medium underground. In principle, it can be assumed that relatively low-density cores can be transported further into the geological formation. The advantage is that the desired effect of keeping the formation open is thus effective for a larger region. The standard test method used here to determine the density of proppants is API RP 60 (specification of the American Petroleum Institute). Accordingly, all density data reported herein are based on this standard test method.

A high acid resistance, particularly with respect to strong acid mixtures such as HCl-HF, is necessary for technocological reasons in crude oil and/or natural gas extraction. The data which follow in this regard are based on the API standard test method (RP 60).

Proppants are known, for example, from DE 19532844 C1. In this and other publications, the proppants consist of purely inorganic components with very high proportions of Al₂O₃, in order to achieve the formation of aluminosilicates or corundum. These minerals have a very high strength, which enables their use as a proppant even at great drilling depths with correspondingly high rock pressures. The aim here is to achieve a high sintering density (low porosity) in the core by virtue of the selection of the starting materials and of the process parameters. Correspondingly, the density of these proppants is relatively high, so that they are deposited at an early stage as the rock formation is filled and do not reach the further regions. This further region is therefore not available for exploitation. Correspondingly, the positive effect achieved in ensuring the permeability of the rock formation is effective only for a narrow region in spite of the active rock mass pressure.

These proppants, and also further purely ceramic proppants, find use without an additional coating. Without a coating, these proppants, however, have relatively high acid solubility.

For the use of proppant, a narrow particle size range is necessary. The current processes for producing these ceramic proppants are, however, associated with the production of a considerable proportion of oversize and/or undersize. The yield of cores within the necessary particle size range is, for example, 40 to 16 mesh at <35%. In addition to this economically unfavourable production method, the task of disposing of oversize and undersize correspondingly occurs.

The disadvantages of low acid resistance can be eliminated in an advantageous manner by coating such ceramic granules, as known, for example, from U.S. Pat. No. 5,218,038 or U.S. Pat. No. 4,969,522, additionally in a quite different manner before their use. The materials coated are, for example, ceramic cores or sands. These coated proppants, however, do not achieve densities of less than 2 g/cm³.

Also known are proppants and processes for their production, which realize the described disadvantages of low acid resistance of ceramic granules without a necessary additional coating by virtue of the proppants being produced by granulation of pulverulent starting materials in combination with liquid resins and subsequent hardening of these resins. The liquid resin serves as a binder in the granulation.

A disadvantage here is, however, that the yield within the necessary narrow size range for use, for example 40 to 16 mesh, is comparably low, as in the case of the ceramic proppants, i.e. <35%. Accordingly, these production processes also constitute an economically unfavourable production method, combined with the considerable disposal task for oversize and undersize which additionally occurs here too.

Granules based on inorganic powders, incorporated into a hardened resin matrix, also have densities of >2 g/cm³. The density in this case can be reduced only by adding organic materials.

The object is achieved in accordance with the invention by a core having a solid powder resin and a finely divided starting material. With regard to the process for producing such a core, the object is achieved by a process of mixing the raw material components and then subjecting the cores to a thermal treatment.

The invention proposes a core which is formed from a raw material mixture which comprises at least one finely divided component, desirably rock flours or glass flours, for example quartz flour, and at least one powder resin.

The raw material mixture is homogenized in a suitable manner, granulated by adding a liquid medium, for example water, and treated thermally in such a way that the powder resin hardens in a suitable manner. This results in a core with very high fracture resistance and is thus particularly suitable as a proppant in the form of the core itself, i.e. without further coating and/or impregnation. A further advantage of such a hardened core over the ceramic products described is, however, the additionally high acid resistance and a low density of <2 g/cm³.

Densities of <2 g/cm³ have already been achieved for the hardened cores which are formed only from rock flour and powder resin, i.e. without the addition of further organic components. In other words: the inventive cores have lower densities than the known cores or proppants described, which are produced from rock flours and liquid resin.

The inventive core is formed at least from one finely divided component and at least one solid powder resin. The solid powder resin may also be a combination of a plurality of powder resins.

The finely divided component may be any type of suitable glass flours or rock flours. These inorganic finely divided components promote particularly the fracture resistance of the hardened core. In a further embodiment, it is also possible to use, instead of some or all of the rock flours, suitable ashes and/or dusts, especially filter dusts from offgas purification or refuse incineration dusts or ashes and/or dusts from other thermal processes. In addition, it is also possible to use suitable finely divided organic components, especially wood dusts, cereal flours and/or polymer dusts. These are incinerated completely during the thermal treatment and ensure additional pore formation in the cores with the consequence of a lower density, and thus have a particularly positive effect on the resulting density of the core. The raw material mixture for the production of the core may consist of the inorganic and/or organic components described, depending upon the necessary properties for the corresponding use of the core, for example as a proppant.

In a further embodiment, the raw material mixture has fibrous materials as a further starting material. The advantage of such fibrous materials is the increase in the strength of the core. In addition, the raw material mixture may also have organic or inorganic binders as further starting materials.

The core desirably has a particle size of 0.2 mm to 2 mm. Such a solid core with such a small particle size is suitable for various applications, especially as a proppant for crude oil and natural gas extraction. Depending on the application, the core may additionally be coated in the thermally treated state, for example with a coating composed of inorganic or organic material, or impregnated.

In the process according to the invention for producing the core, instead of the known liquid resin, the starting material used for the raw material mixture is powder resin. To bind the raw material mixture in the course of granulation, instead of liquid resin, another suitable binder is used. As early as in the course of granulation with water, the active binding forces are sufficient to form a suitable granule. Alternatively, or to further increase the binding forces, the addition of alternative or additional binders, for example sizes, is conceivable. The binders may be added in solid and/or liquid form to the raw material mixture and/or of the liquid granulation or suspension medium (for example water). This is advantageous particularly when the physical stress on the untreated cores (also known as green granules) in the subsequent process steps is high and the binding action of the starting materials is insufficient therefor.

In the case of granulation with water, the water evaporates in the course of the subsequent thermal treatment of the granules. The powder resin melts first, at least partly or completely surrounds the fine particles, for example of glass flour or rock flour, and then hardens. Some of the water released in this working example leaves behind pores in the core. In spite of a resulting high pore fraction, largely good fracture resistances are achieved with low densities in the inventive core in the thermally treated state.

The density of the proppant can additionally be lowered by adding suitable organic components (solid or liquid). This desirably achieves densities of <1.6 g/cm³ and fracture resistances of <2%.

A particular advantage of the inventive method proposed here is that the resulting size band in the granulation is significantly narrower than in the other processes described. The size band achieved by a granulation process is dependent upon a whole variety of influencing factors. For example, the raw material components used, for example the fineness and/or the surface properties of these components, influence the resulting size band in conjunction with the liquid medium used for granulation. The type and the properties of the liquid medium, for example the viscosity, likewise have an effect on the resulting size band. The inventive selection of the raw material components and the use of a liquid medium for granulation which is not a liquid resin leads to the described significant increase in the yield within the desired size range by narrowing the size band after the granulation.

Addition of organic and/or inorganic fibres can achieve an additional increase in the fracture resistance. The fibres which may be used are those which do not melt in the course of the subsequent thermal treatment. It has to be ensured that the fibres are efficiently surrounded by the molten resin powder and correspondingly then bonded in a fixed manner within the hardened matrix.

It is also possible to use fibre material in which the fibres melt partly or completely within the temperature range used in the thermal treatment. This is advantageous especially when sufficient surrounding of the fibres by the molten resin in the thermal process cannot be ensured. Slight melting of the fibre material in the interface region forms an intimate bond to the structure, with the desired consequence of increasing strength. The quantity of (slight) melting of the fibres must not, however, be to such an extent that the structure of the fibres in the thermally treated structure is lost. The fibres used are, for example, ceramic fibres and/or natural fibres and/or carbon fibres and/or glass fibres.

For further processing of the inventive raw material mixtures, two different process sequences, both of which lead to a core with the inventive properties, may be performed:
a) Suitable homogenization of the raw material components, granulation of the raw material mixture with the aid of a suitable liquid medium and subsequent thermal treatment, i.e. curing of the powder resin.
b) Addition of a suitable liquid medium to the raw material mixture and subsequent spraying of this suspension (slip) in a thermal reactor, for example spray drier or fluidized bed, in such a way that a suitable granule is formed. The necessary hardening of the resin can advantageously be effected completely or partly within this thermal reactor, or subsequently in a downstream thermal process.

Description of process a):
The inventive raw material mixture is homogenized and granulated in a suitable manner, for example in a mixer. To this end, a suitable liquid medium, for example water, is added to the dry raw material mixture. To increase the strength of the granule produced in the granulation, it is possible to add additional binders, for example sizes. These may be added in solid and/or liquid form to the raw material mixture and/or of the liquid granulation medium (for example water).
To further increase the yield in the desired size fraction, so-called seeds can be added to the raw material mixture before and/or during the granulation. The size band of these seeds is desirably below the size band of the desired size fraction of the fired core material. A possible necessary pretreatment of the seeds to improve the adhesion properties on the seed surface can be effected separately or within the granulation process. In one embodiment, the undersize of the hardened proppant can be used as a seed for the granulation. The advantage here is the reduction of the undersize which cannot be used in addition to the further increase in the yield, for example within the 40 mesh to 20 mesh size range of >60%. In a further embodiment, other cores, for example with low densities, can be added before or during the granulation, and then receive a coating by the further raw material components including the powder resin in the course of granulation. In addition to positive influence on the yield with suitable selection of the size band of the particles, it is thus possible to positively influence further properties, especially the density of the hardened core.
In a further embodiment, fibrous materials can be added to the raw material mixture. These are added as a constituent of the raw material mixture before or during the granulation. The advantage of such fibrous materials is the increase in the strength, both of the green granules and of the hardened core.
The granulated granule which is yet to be (completely) hardened (green granule or raw granule) can additionally be powdered with a separating agent in order to prevent agglomerations in the course of handling and/or in the course of further process steps, for example in the course of the thermal treatment for hardening the powder resin. The separating agent is desirably applied in the mixer directly after the granulation, but it is alternatively also possible to select other points in the process chain for the application, for example by blowing into the thermal reactor at melt temperature of the powder resin.
The subsequent thermal process serves to solidify the core by curing the powder resin. This initially melts the solid powder resin which surrounds the other components added and then hardens, i.e. by virtue of liquid resin crosslinking. The thermal treatment can be effected in suitable thermal reactors, for example driers, in a direct or indirect rotary tube oven or in a fluidized bed reactor.

Description of process b):
A suitable suspension (slip) is prepared from the raw material mixture. To this end, a suitable liquid medium, preferably water, is added to the raw material mixture.
To adjust the necessary properties of the suspension, for example flow behaviour, suitable assistants, for example flow aids, may be added. It is also possible for additional binders, for example sizes, to be part of the suspension prepared. This suspension is suitably introduced into a thermal reactor, for example a spray drier or a fluidized bed reactor, in such a way that highly spherical particles with a narrow particle size distribution form as far as possible within the desired size band.
To improve the particle formation, a suitable core material, either inorganic or organic, may be added. It may be added to the suspension and/or directly in the thermal reactor.
The process temperature and the residence time in the thermal reactor are preferably selected such that both the drying of the cores and the hardening of the resin, i.e. initially the melting of the powder resin and the subsequent curing by crosslinking of the resin which is then liquid, proceed in the course of this thermal treatment. Alternatively, it is also possible to initially realize only the shaping and drying with only partial, if any, hardening of the resin. The subsequent complete hardening is effected in an additional thermal treatment stage.

Both production processes a) and b) lead to a core with the inventive properties which can then additionally be coated further and/or impregnated in order to increase certain properties, for example wettability in liquid media. This additional coating can be effected separately after the core production. A further embodiment is the coating or impregnation during the production process, for example in the region of the cooler by, for example, spray application.

The advantages achieved with the invention consist in particular in that the use of powder resins—instead of liquid resins—and granulation with another liquid medium which is now necessary, for example water, give rise to particular advantages for the production process and the properties of the resulting proppant.

Advantageous raw material composition and advantageous configuration of the production process result in the significant advantages summarized below:
The yield of desired size fraction rises significantly; for example over 60% can be achieved within the 40-16 mesh fraction. This results in a significant rise in the economic efficiency of the production process and the significant reduction of oversize and/or undersize.
Significantly lower densities for the cores are achieved, while the fracture resistances achieved are comparable to the known fracture resistance for cores with high densities.
The acid resistance of the cores is significantly higher than in the case of ceramic proppants and is likewise higher than in the case of resin-coated, or shaped, cores.

Examples of such particularly advantageous raw material mixtures and of the advantageous configuration of the production process are indicated by the working examples.

Working examples of the invention are illustrated in detail with reference to drawings.

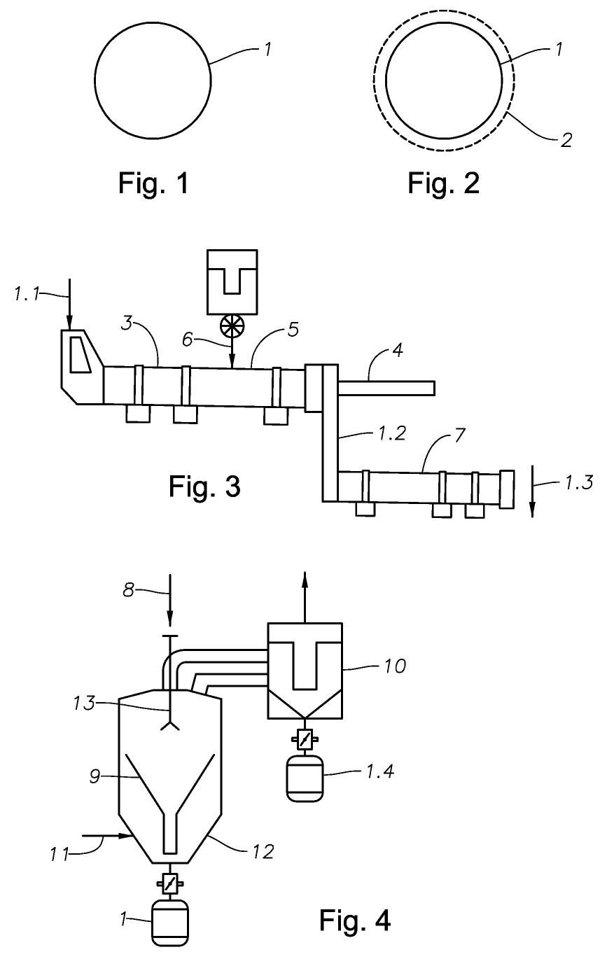

FIG. 1 a schematic sectional view of a core without coating

FIG. 2 a schematic sectional view of a core with coating

FIG. 3 a schematic view of a rotary tube oven system for the thermal treatment

FIG. 4 a schematic view of a fluidized bed system for the thermal treatment.

Mutually corresponding parts are provided with the same reference numerals in all figures.

FIG. 1 shows one embodiment of a core 1. The core 1, essentially with spherical dimensions, here in the embodiment without coating. The core 1 is shown as a hardened core in the thermally treated state, which is formed from a raw material mixture composed of powder resin and a finely divided starting material. The core 1 has a density of less than 2 g/cm³ in the thermally treated state.

FIG. 2 shows an embodiment of a core 1 with a coating 2. The core 1 with spherical dimensions is surrounded by a coating 2, as indicated by the dotted line.

FIG. 3 shows a rotary tube oven 3 as an example of a possible embodiment of a system for the thermal treatment of thermally untreated cores 1.1 (also known as green granules). The thermally untreated core 1.1 with the above-described composition composed of at least one rock flour or glass flour component and at least one powder resin is fed to the thermal process. The rotary tube oven 3 can be heated indirectly, for example by external electrical heating rods, or directly, for example by a burner. Alternatively, instead of a rotary tube oven 3, a fluidized bed reactor can be used (see FIG. 4).

The working example according to FIG. 3 shows a rotary tube oven 3 with direct firing by a burner 4. A protective tube is mounted above the burner 4 in such a way that the flame of the burner 4 does not have direct contact with the material bed (the cores 1.1). This prevents the temperature in the material bed from rising locally above the desired temperature. The untreated cores 1.1 are fed to the rotary tube oven 3 and thermally treated in the firing zone 5 heated by the burner 4. A separating agent 6, for example quartz flour or corundum flour, may additionally be introduced into the firing zone 5. The thermally treated cores 1.2 are withdrawn from the rotary tube oven 3 and cooled in the drum cooler 7. At the end of the drum cooler 7, the cooled cores 1.3 can, depending on the requirement, be packaged or fed to a further treatment step, for example a coating or impregnation process. Alternatively, the coating can also be performed during the cooling, for example in the course of spraying.

FIG. 4 shows a fluidized bed system 12 as an example of a possible embodiment of a system for producing the desired core form and the thermal treatment of these cores 1.

A suitable suspension (slip) 8 is prepared from the raw material mixture with composition described above. To this end, a suitable liquid medium, desirably water, is added to the raw material mixture. To attain the necessary properties of the suspension 8, for example flow behaviour, suitable assistants, for example flow agents, can be added. Also, additional binders, for example sizes, may be part of the suspension 8 prepared.

This suspension 8 is suitably introduced into the fluidized bed reactor 12 via a two-substance nozzle 13 continuously in such a way that highly spherical particles are formed with a narrow particle distribution as far as possible within the desired size band.

The material temperature is controlled in such a way that, in the course of the resulting residence time in the fluidized bed reactor, the resin hardens completely as a constituent of the core 1. The process gas necessary for this purpose is generated in a hot gas generator 11. A separator 10 is adjusted in such a way that only thermally treated cores 1.2 with the desired particle size are discharged. Excessively small, thermally treated cores 1.2 pass back into the reaction chamber 9 as seeds. At the end of the separator 10, the cooled cores 1.4, depending on the requirements, can be packaged or sent to a further treatment step, for example a coating or impregnation process.

Some preferred working examples for the production of cores 1 by the above-described process are specified below.

### Working Example 1

In Working Example 1, the raw material components
50% quartz flour
25% wheat flour
25% powder resin (Bakelite 223 SP)
   are homogenized in a mixer. The granulation is effected in the same mixer with addition of water. The granule which forms is subsequently powdered with quartz flour (10% on dry mass).

The resulting untreated green granule (=untreated cores 1.1) is then introduced into the rotary tube oven 3. The maximum temperature in the sintering zone 5 is 180° C.±10° C. Subsequently, the cores 1.2 are cooled in the drum cooler 7 to <50° C.

The screened-off fraction of the treated and cooled granule (=thermally treated cooled cores 1.3) with a screen (40 mesh to 20 mesh) has the following product specification:

TABLE 1
Cores without coating (Working Example 1)

| | | | |
|---|---|---|---|
| Bulk density | | [g/cm³] | 0.70 |
| Density | to API RP 60 | [g/cm^{3]} | 1.50 |
| Crash test | to API RP 60 | [%] | 0.8 |
| | (at 2,000 psi) | | |
| Roundness | at API RP 60 | [—] | 0.8/0.8 |
| Acid solubility | at API RP 60 | [%] | 1.84 |

API RP 60 means a specification of the American Petroleum Institute, which recommends test conditions for bulk materials, especially for high-strength granules or cores which are used for hydraulic fracturing.

### Working Example 2

In Working Example 2, the raw material components
65% glass powder
28% powder resin (Bakelite 223 SP)
7% cellulose
   are homogenized in a mixer. The granulation is effected in the same mixer with addition of water. The cellulose added serves as an additional binder.

The resulting untreated green granule 1.1 is then introduced into the rotary tube oven 3. The maximum temperature in the sintering zone 5 is 180° C.±10° C. Subsequently, the thermally treated cores 1.2 are cooled in the drum cooler 7 to <50° C. The screened-off fraction of the treated and cooled cores 1.3 with a screen (40-2 mesh) has the following product specification:

TABLE 2
Cores without coating (Working Example 2)

| | | | |
|---|---|---|---|
| Bulk density | | [g/cm³] | 0.85 |
| Density | to API RP 60 | [g/cm³] | 1.80 |
| Crash test | to API RP 60 | [%] | 0.71 |
| | (at 2,000 psi) | | |
| Roundness | at API RP 60 | [—] | 0.8/0.7 |
| Acid solubility | at API RP 60 | [%] | 1.71 |

### Working Example 3

In Working Example 3, the raw material components
60% glass powder
30% powder resin (Bakelite 223 SP)
10% Al(OH)₃
   are homogenized in a mixer. The granulation is effected in the same mixer with addition of dilute phosphoric acid. In this working example, approx. 9% phosphoric acid, based on the dry mass of the raw material mixture, was added in the granulation. The addition of Al(OH)₃ and phosphoric acid serve here as an additional binder through the resulting formation of aluminium phosphate (hydrates). The green granule thus produced (untreated cores 1.1) is subsequently introduced into the rotary tube oven 3. The maximum temperature in the sintering zone 5 is 180° C.±10° C. Subsequently, the thermally treated cores 1.2 are cooled in the drum cooler 7 to <50° C.

The screened-off fraction of the treated and cooled cores 1.3 with a screen (40-20 mesh) has the following product specification:

TABLE 3
Cores without coating (Working Example 3)

| | | | |
|---|---|---|---|
| Bulk density | | [g/cm³] | 0.82 |
| Density | to API RP 60 | [g/cm³] | 1.72 |
| Crash test | to API RP 60 | [%] | 0.83 |
| | (at 2,000 psi) | | |
| Roundness | at API RP 60 | [—] | 0.7/0.7 |
| Acid solubility | at API RP 60 | [%] | 1.98 |

### Working Example 4

In Working Example 4, a slip is prepared from the raw material components:
60% glass powder
30% powder resin (Bakelite 223 SP)
10% cellulose
   by adding water. This slip is subsequently sprayed into a fluidized bed reactor in such a way that thermally treated cores 1.2 of the desired shape form. The end temperature of the material layer in the fluidized bed is 180° C.±5° C., in order to realize complete curing of the powder resin actually within the fluidized bed reactor.

The screened-off fraction of the treated and cooled cores 1.3 with a screen (40-20 mesh) has the following product specification:

TABLE 4
Cores without coating (Working Example 4)

| | | | |
|---|---|---|---|
| Bulk density | | [g/cm³] | 0.85 |
| Density | to API RP 60 | [g/cm³] | 1.77 |
| Crash test | to API RP 60 | [%] | 0.63 |
| | (at 2,000 psi) | | |
| Roundness | at API RP 60 | [—] | 0.8/0.8 |
| Acid solubility | at API RP 60 | [%] | 1.81 |

1. A proppant comprising a core which is formed from a raw material mixture comprising at least a solid powder resin and a further finely divided starting material, and has been thermally treated at a temperature not exceeding about 220° C., and which in the thermally treated state, has a density of less than 2 g/cm³.

2. The proppant of claim 1 wherein the raw material mixture comprises a member selected from the group consisting of finely divided rock flour, finely divided glass flour, ash or dusts from thermal processes, and mixtures thereof.

3. The proppant of claim 2, wherein the raw material mixture further comprises organic materials.

4. The proppant of claim 3 wherein the organic materials comprise a member selected from the group consisting of wood dusts, cereal flours, polymer dusts and mixtures thereof.

5. The proppant of claim 1 wherein the raw material mixture further comprises fibrous materials.

6. The proppant of claim 1, wherein the raw material mixture further comprises organic or inorganic binders.

7. The proppant of claim 1 having a particle size of 0.2 mm to 2 mm.

8. A process for producing the core of claim 1 comprising mixing the raw material mixture components to form a raw material mixture and granulating to form cores, then subjecting the cores to a thermal treatment in the temperature range of about 120° C. to about 220° C.

9. The process of claim 8 further comprising:
conditioning and mixing the raw material mixture at the same time to form a suspension, spraying the suspension into a thermal reactor, and
subjecting the cores to a thermal treatment.

10. The process of claim 8 further comprising adding a liquid medium before, during or after the mixing.

11. The process of claim 8 further comprising adding liquid or solid assistants before, during or after the mixing.

12. The process of claim 9 further comprising adding particle seeds of hardened cores before or during the granulation or the suspension.

13. The process of claim 8 further comprising utilizing a separating agent.

14. The process of claim 13 wherein the cores are powdered with the separating agent before the thermal treatment.

15. The process of claim 9 wherein the thermal treatment dries and completely hardens the powder resin.

16. The process of claim 9 wherein the thermal treatment only partially hardens the powder resin.

17. The process of claim 16 wherein a subsequent thermal treatment completes the hardening of the powder resin.

18. The process of claim 8 further comprising coating or impregnating the cores.

19. A process for treating an underground geological formation comprising introducing a proppant of claim 1 into the underground geological formation.

20. The process of claim 19 wherein the treating is done during hydrofracing.
